(19) United States
(12) Patent Application Publication
(10) Pub. No.: US 2023/0284239 A1
(43) Pub. Date: Sep. 7, 2023

(54) Dynamic PDCCH Power Allocation LTE Feature

(71) Applicant: Parallel Wireless, Inc., Nashua, NH (US)

(72) Inventors: Mohammad Jamal, Baqa-jatt (IL); Ran Leviev, Yokneam Llit (IL); Ido Shaked, Alfei Menashe (IL)

(21) Appl. No.: 18/168,568

(22) Filed: Feb. 13, 2023

Related U.S. Application Data
(60) Provisional application No. 63/309,039, filed on Feb. 11, 2022.

(51) Int. Cl. H04W 72/232; H04W 72/044; H04W 72/1263

(52) U.S. Cl. CPC H04W 72/232; H04W 72/0473; H04W 72/1263

(57) ABSTRACT

A method is disclosed of providing dynamic Physical Downlink Control Chanel (PDCCH) power allocation, comprising: dividing a transmit power over all resource elements (REs) in a subframe at a first symbol time; determining how many REs will be in use at a second symbol time; determining how much additional power will be available at the second symbol time; and dividing and allocating at least a portion of the determined additional power over REs assigned for PDCCH resources for use during the second symbol time.

### CROSS-REFERENCE TO RELATED APPLICATIONS

This application claims priority under 35 U.S.C. § 119(e) to U.S. Provisional Pat. App. No. 63/309,039, filed Feb. 11, 2022, titled “Dynamic PDCCH Power Allocation LTE Feature,” which is hereby incorporated by reference in its entirety for all purposes. This application also hereby incorporates by reference, for all purposes, each of the following U.S. patent application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

In Long Term Evolution (LTE), which uses orthogonal frequency division multiple access (OFDMA), radio resources are 2D regions over time (an integer number of OFDM symbols) and frequency (a number of contiguous or non-contiguous subcarriers). Similar to OFDM, OFDMA employs multiple closely spaced subcarriers in a subframe that are divided into groups of subcarriers where each group is called a resource block.

Within a subframe, various resource blocks are designated with specific functions. The physical downlink control channel (PDCCH) is a physical channel that carries downlink control information (DCI). PDCCH is mapped to the first L OFDM symbols in every downlink subframe, where L is either 1, 2, or 3 based on the physical control format indicator channel (PCFICH). Essentially, since this downlink control information is needed to receive any downlink information, it is critical for the UE to properly receive and decode the PDCCH.

PDCCH downlink power allocation can vary from cell to cell and furthermore it can be device-specific. These settings—beside many others—will have an impact on the performance of an LTE-capable device. And data throughput is, of course, a performance criteria that not only network, but also affect user experience.

### SUMMARY

The power of signal components like PDCCH may be either Static or Dynamically allocated (dynamic power allocation), which this feature in our paper deals and proposes methods and algorithms for.

The overall goal of our feature is to have a dynamic power for PDCCH Allocation that can change from subframe to subframe, without affecting the ratio of P_{A} and P_{B} and while allowing overall OFDM symbol power to remain constant, even when the PDCCH allocation is changed.

In one embodiment, a method is disclosed of providing dynamic Physical Downlink Control Chanel (PDCCH) power allocation, comprising: dividing a transmit power over all resource elements (REs) in a subframe at a first symbol time; determining how many REs will be in use at a second symbol time; determining how much additional power will be available at the second symbol time; and dividing and allocating at least a portion of the determined additional power over REs assigned for PDCCH resources for use during the second symbol time.

The method may further comprise performing the method at a scheduler in communication with an eNodeB. The method may further comprise performing the method at a network node performing media access control (MAC) scheduling. The first symbol time and the second symbol time may be two transmission time intervals (TTIs) apart, or may be at least two transmission time intervals (TTIs) apart. The method may further comprise performing the method in a multi-radio access technology (multi-RAT) telecommunications network.

The method may further comprise evenly dividing a transmit power over all resource elements (REs) in a subframe at a first symbol time, and, evenly dividing and allocating the determined additional power over REs assigned for PDCCH resources for use during the second symbol time. The method may further comprise allocating a portion of the determined additional power to a cell specific reference signal. The method may further comprise selecting a lower aggregation level for an eNodeB signal. The method may further comprise determining the transmit power based on a power level available at an antenna of the eNodeB. The method may further comprise adding power based on a number of unused subcarriers at the first symbol time.

### BRIEF DESCRIPTION OF THE DRAWINGS

FIG. 1 is a plot of QPSK encoding for an exemplary signal, in accordance with some embodiments.

FIG. 2A is a schematic diagram of an aggregation level, as known in the prior art.

FIG. 2B is a schematic diagram of an enhanced aggregation level, in accordance with some embodiments.

FIG. 3 is a flow diagram in a first state, in accordance with some embodiments.

FIG. 4 is a flow diagram in a second state, in accordance with some embodiments.

FIG. 5 is an architecture diagram of a multi-RAT network architecture, in accordance with some embodiments.

FIG. 6 is a schematic diagram of a base station, in accordance with some embodiments.

### DETAILED DESCRIPTION

PDCCH Dynamic power control lowers interference, expands cell capacity, and increases coverage while meeting users QoS requirements. and in fact, this is our recommendation because the AMC function can meet the requirement of QoS.

The PDCCH power boosting compensates for path loss and shadow fading and counteracts the bad quality links, reduces interference on the edge cell, better efficiently use of CCEs and there's no power wasted.

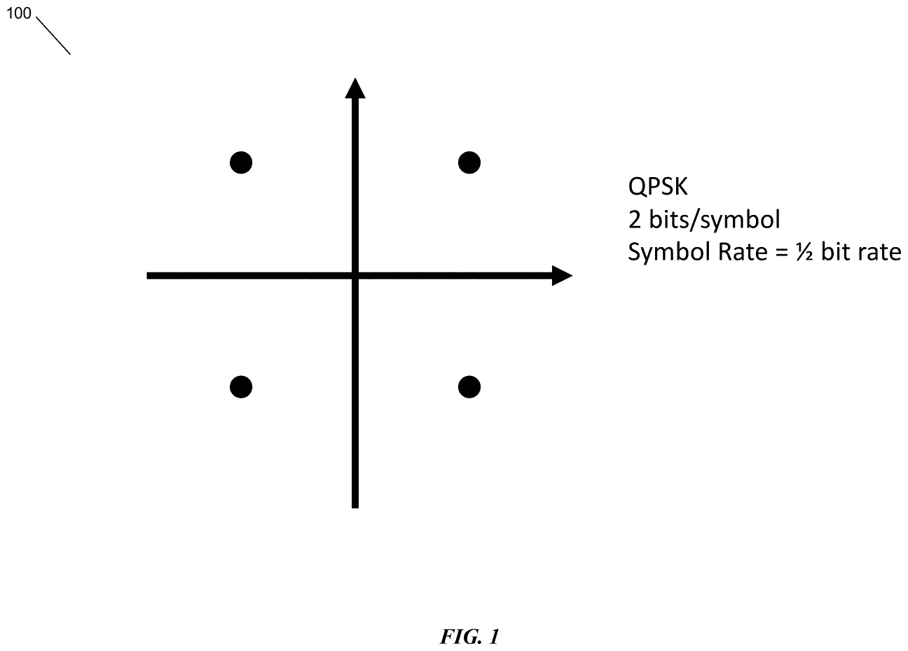

FIG. 1 shows QPSK modulation of an exemplary signal, in accordance with some embodiments. The PDCCH channel has QPSK modulation so even we increase/decrease power it will move the red point at the receiver slightly (see please photo below) and we would still be on the same quadrant, So the receiver will decode it as QPSK. This means for example, if the red point is on quadrant 1 (x positive, y positive) without using our feature (dynamic PDCCH power) then if we increase/decrease PDCCH power dynamically (i.e using our feature proposal) then the same point would move but because it would stay on the same quadrant so the receiver will still decode it correctly as QPSK because we just having one red point per quadrant in QPSK. Therefore we conclude that our feature isn't affecting EVM of PDCCH decoding and therefore EVM isn't that much critical.

Do our feature affect ratio P_{A}/P_{B}? No it will not be affected, there's no relation to that ratio over what we propose in our paper.

Our feature is called Dynamic PDCCH power Control for boosting PDCCH. by this feature the eNodeB selects appropriate PDCCH transmit power based on the power of unused REs/subcarriers by our suggested algorithm in our paper further. This feature works only for FDD. by our feature the eNodeB selects a lower aggregation level and increases the transmit power to ensure the PDCCH demodulation performance, it allows the PDCCH to support more UEs, increase PDCCH capacity therefore cell throughput increases, increase the uplink and downlink throughput. Therefore we would see much improvement in PDCCH success and DCi decoding from UE side.

Note: PDCCH dynamic power algorithm of our feature mentioned below.

Dynamic PDCCH power's feature gain: Having additional power upon PDCCH REs which we will get much better SINR specifically for DCIs decoding; CCE allocation success rate increases; eNB Selects lower aggregation level and ensures PDCCH demodulation performance; Increasing probability to decode PDCCH without reducing modulation for PDCCH; No power wasted on empty unused RE since we use that power upon PDCCH Res; High decoding success rate of PDCCH; Increasing PDCCH capacity within same aggregation level (Same CFi); UES at cell edge can easily decode PDCCH with our feature applied; More efficient use of CCEs—by using low aggregation levels because of having more additional Power and better SINR for PDCCH.

Lowering aggregation level for PDCCH scenarios, it means we can now implicitly populate more candidates per aggregation level. There's a photo below elaborate the main idea since we applied additional power for PDCCH symbols so we implicitly can populate candidates on second floor (power).

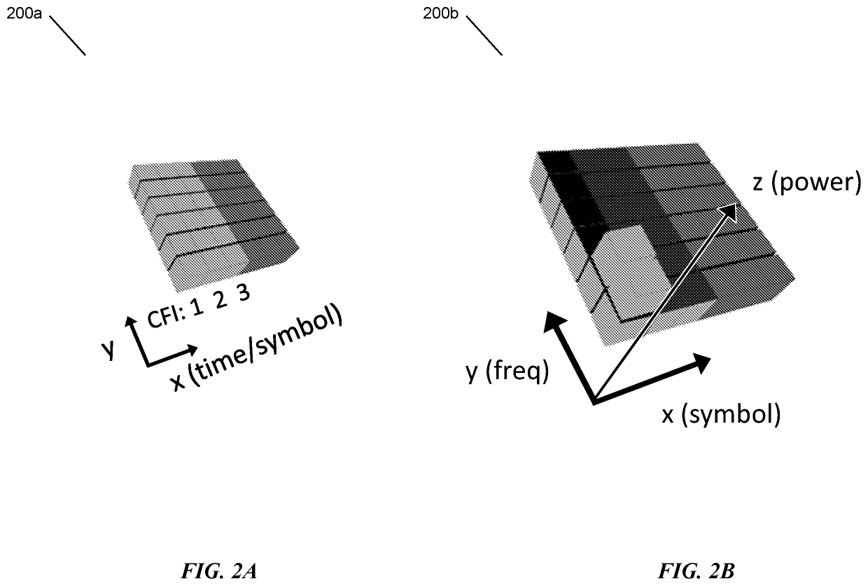

FIG. 2A shows a schematic CFI, in accordance with the prior art. Without using our feature we have maximum cfi 3, where X axis is time (symbol), Y axis is frequency, Z axis is power and we don't care about it because power is fixed assignment (not dynamic) so implicitly Z axis isn't needed.

FIG. 2B shows a schematic CFI, in accordance with some embodiments. With our proposed feature used (dynamic PDCCH power): So here we care about z axis (power) because we have now additional power for PDCCH symbols from unused REs (unused subcarrier), and therefore we implicitly can populate more candidate in new upstairs floor within same CFIs 1, 2, 3.

Regarding to our feature, Total available power isn't changed; Consequently, EVM isn't affected. In LTE the whole symbol is allocated to PDCCH so the additional power comes from non used subcarriers that comes from total available subcarrier for PDCCH.

Problem: Low SNIR for PDCCH REs, Low success Rate for PDCCH decoding (DCis decoding), bad efficient use of CCEs, high blocking probability for PDCCH, wasted power in vain for unused REs/subcarriers.

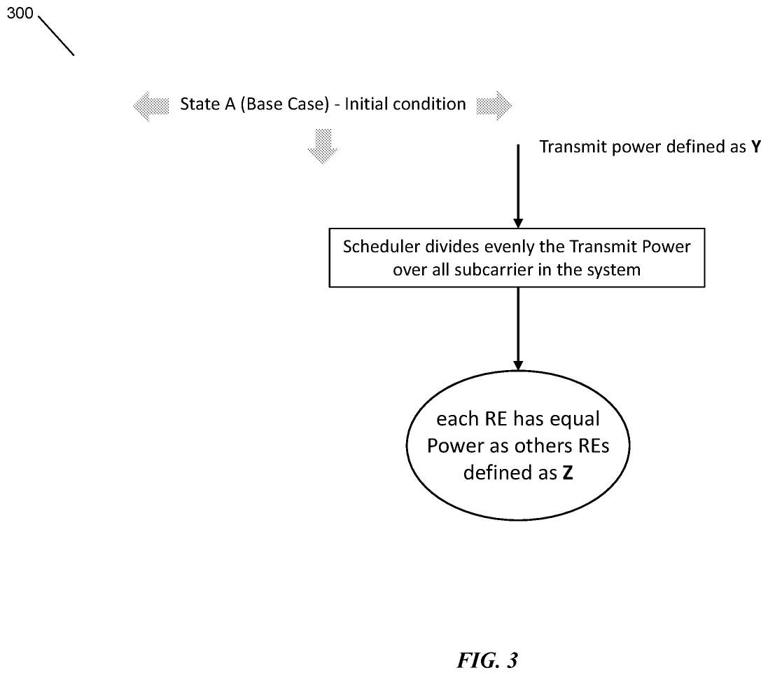

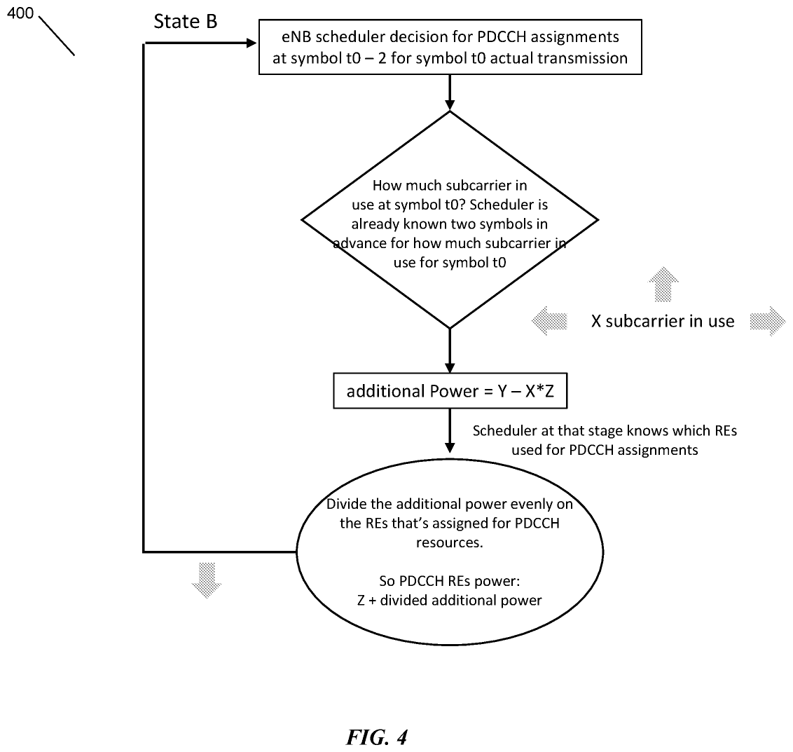

Solution to problem: Parallel wireless (PW) architecture can provide a solution to this problem by just updating in the eNB MAC scheduler a simple function that follows our proposal Pseudo Code Algorithm, as shown in FIGS. 3 and 4.

Algorithm: Lemma (Fact): Mac Scheduler of eNB works 2 symbols in advance to actual transmission, it means the Mac Scheduler of eNB assigns resources 2 symbols beforehand for the actual transmission. For example, the resources for time t+2 is already determined and prepared in time t. the decision what will be sent at symbol t0 is made at symbol t0-2. And for the scheduler at each decision (t0) is already known beforehand at t0-2 at which channels those REs are used for, like for PDCCH or PDSCH or PHICH etc.

As shown in FIG. 3, State A—Start condition: We divide evenly the Transmit Power of antenna over all subcarrier (REs) that we have in our system. So each RE has same power as others. Evenly or another division may be used, in some embodiments.

As shown in FIG. 4, at State B—At each scheduler decision divide Transmit Power on number of subcarrier that is in use per each symbol. It means that we divide the Transmit power over the REs (subcarriers) that is in use in symbol t0 and this assignment decision already known in t0-2 because in LTE the MAC scheduler makes decisions 2 symbols in advance. A different number of symbols in advance may be used, in some embodiments.

The additional power that we have per each scheduler decision we assign it to the PDCCH REs only. Doing the same algorithm steps in loop starting from step 2 (state B) at each scheduler decision (at each PDCCH recourses/REs assignment). Note: for just simplification I assumed that each subcarrier has just 1 RE but it doesn't matter for the algorithm whereas theoretically each subcarrier has deterministic amount of REs. So as you can see here implicitly saying subcarrier or 1 RE is the same meaning.

If I say X subcarrier in use same as saying X REs in use (1 RE each subcarrier). Note: X subcarrier in use in other words X REs in use.

Detailed concrete example to clarify more and simplify our algorithm concept and its functionality follows. Assume we have: Transmit power of the antenna=10 watt; 10 Res. Lets number the REs as RE1, RE2, RE3, RE4, RE5, . . . , RE10.

According to State A, we distribute/divide the power evenly between all REs we have in the system so here in our case each RE=1 watt. i.e the pdcch RES: RE9=1 watt, RE10=1 watt.

Now the scheduler at symbol t0 wants to transmit REs, we know that the scheduler is already known at t0-2 symbol of how much REs to transmit in t0. So assume that we transmit only 6 REs (RE1 to RE6) in symbol t0 and assume RE1 and RE2 is considered by the scheduler as PDCCH REs at symbol t0 (those REs for PDCCH assignment in symbol t0). Therefore, we have in symbol t0 4 watts unused so those 4 watts we divide them evenly over the PDCCH REs. As a result, we get:

PDCCH REs in symbol t0:
RE1=1 watt+2 watt(additional power)=3 watt.
RE2=1 watt+2 watt(additional power)=3 watt.

Other REs in symbol t0 (RE3-to-RE6)=1 watts for each RE.

So as you see RE1 and RE2 we have more power because there REs are for PDCCH and that's what our feature proposes, more power more better SINR and then we can lower aggregation level for UEs cell edge instead of consuming 8 CCEs, by our feature, users at cell edges consumes 4 CCEs and can easily decode PDCCH REs.

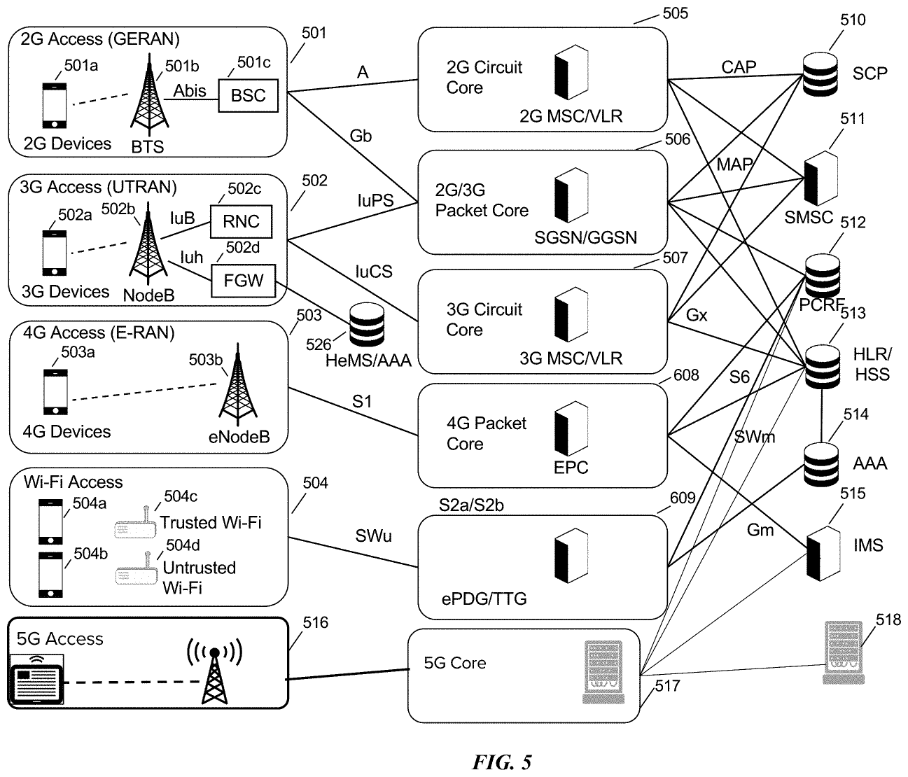

FIG. 5 is a schematic network architecture diagram for 3G and other-G prior art networks. The diagram shows a plurality of “Gs,” including 2G, 3G, 4G, 5G and Wi-Fi. 2G is represented by GERAN 501, which includes a 2G device 501a, BTS 501b, and BSC 501c. 3G is represented by UTRAN 502, which includes a 3G UE 502a, nodeB 502b, RNC 502c, and femto gateway (FGW, which in 3GPP namespace is also known as a Home nodeB Gateway or HNBGW) 502d. 4G is represented by EUTRAN or E-RAN 503, which includes an LTE UE 503a and LTE eNodeB 503b. Wi-Fi is represented by Wi-Fi access network 504, which includes a trusted Wi-Fi access point 504c and an untrusted Wi-Fi access point 504d. The Wi-Fi devices 504a and 504b may access either AP 504c or 504d. In the current network architecture, each “G” has a core network. 2G circuit core network 505 includes a 2G MSC/VLR; 2G/3G packet core network 506 includes an SGSN/GGSN (for EDGE or UMTS packet traffic); 3G circuit core 507 includes a 3G MSC/VLR; 4G circuit core 508 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 530, the SMSC 531, PCRF 532, HLR/HSS 533, Authentication, Authorization, and Accounting server (AAA) 534, and IP Multimedia Subsystem (IMS) 535. An HeMS/AAA 536 is present in some cases for use by the 3G UTRAN. The diagram is used to indicate schematically the basic functions of each network as known to one of skill in the art, and is not intended to be exhaustive. For example, 5G core 517 is shown using a single interface to 5G access 516, although in some cases 5G access can be supported using dual connectivity or via a non-standalone deployment architecture.

Noteworthy is that the RANs 501, 502, 503, 504 and 536 rely on specialized core networks 505, 506, 507, 508, 509, 537 but share essential management databases 530, 531, 532, 533, 534, 535, 538. More specifically, for the 2G GERAN, a BSC 501c is required for Abis compatibility with BTS 501b, while for the 3G UTRAN, an RNC 502c is required for Iub compatibility and an FGW 502d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

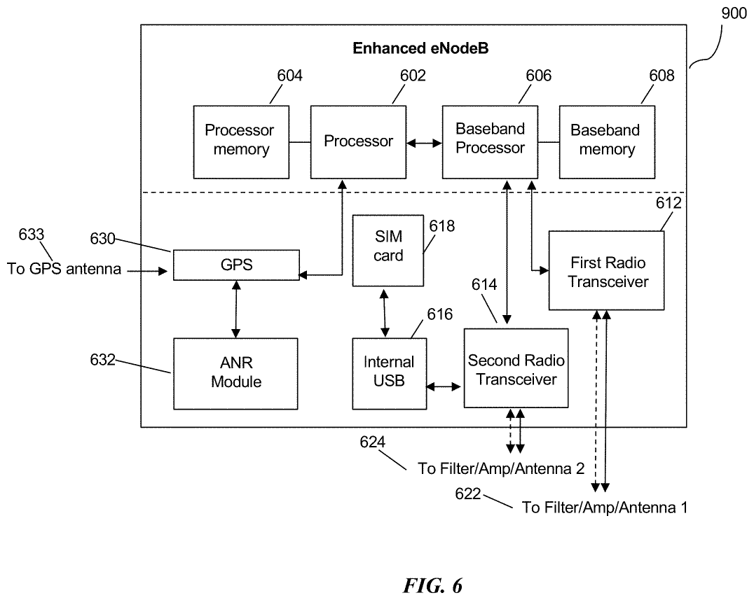

FIG. 6 is an enhanced eNodeB for performing the methods described herein, in accordance with some embodiments. Mesh network node 600 may include processor 602, processor memory 604 in communication with the processor, baseband processor 606, and baseband processor memory 608 in communication with the baseband processor. Mesh network node 600 may also include first radio transceiver 612 and second radio transceiver 614, internal universal serial bus (USB) port 616, and subscriber information module card (SIM card) 618 coupled to USB port 616. In some embodiments, the second radio transceiver 614 itself may be coupled to USB port 616, and communications from the baseband processor may be passed through USB port 616. The second radio transceiver may be used for wirelessly backhauling eNodeB 600.

Processor 602 and baseband processor 606 are in communication with one another. Processor 602 may perform routing functions, and may determine if/when a switch in network configuration is needed. Baseband processor 606 may generate and receive radio signals for both radio transceivers 612 and 614, based on instructions from processor 602. In some embodiments, processors 602 and 606 may be on the same physical logic board. In other embodiments, they may be on separate logic boards.

Processor 602 may identify the appropriate network configuration, and may perform routing of packets from one network interface to another accordingly. Processor 602 may use memory 604, in particular to store a routing table to be used for routing packets. Baseband processor 606 may perform operations to generate the radio frequency signals for transmission or retransmission by both transceivers 610 and 612. Baseband processor 606 may also perform operations to decode signals received by transceivers 612 and 614. Baseband processor 606 may use memory 608 to perform these tasks.

The first radio transceiver 612 may be a radio transceiver capable of providing LTE eNodeB functionality, and may be capable of higher power and multi-channel OFDMA. The second radio transceiver 614 may be a radio transceiver capable of providing LTE UE functionality. Both transceivers 612 and 614 may be capable of receiving and transmitting on one or more LTE bands. In some embodiments, either or both of transceivers 612 and 614 may be capable of providing both LTE eNodeB and LTE UE functionality. Transceiver 612 may be coupled to processor 602 via a Peripheral Component Interconnect-Express (PCI-E) bus, and/or via a daughtercard. As transceiver 614 is for providing LTE UE functionality, in effect emulating a user equipment, it may be connected via the same or different PCI-E bus, or by a USB bus, and may also be coupled to SIM card 618. First transceiver 612 may be coupled to first radio frequency (RF) chain (filter, amplifier, antenna) 622, and second transceiver 614 may be coupled to second RF chain (filter, amplifier, antenna) 624.

SIM card 618 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 600 is not an ordinary UE but instead is a special UE for providing backhaul to device 600.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 612 and 614, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 602 for reconfiguration.

A GPS module 630 may also be included, and may be in communication with a GPS antenna 632 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 632 may also be present and may run on processor 602 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

In 5GC, the function of the SGW is performed by the SMF and the function of the PGW is performed by the UPF. The inventors have contemplated the use of the disclosed invention in 5GC as well as 5G/NSA and 4G. As applied to 5G/NSA, certain embodiments of the present disclosure operate substantially the same as the embodiments described herein for 4G. As applied to 5GC, certain embodiments of the present disclosure operate substantially the same as the embodiments described herein for 4G, except by providing an N4 communication protocol between the SMF and UPF to provide the functions disclosed herein.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure. While the present method and system is described relative to a 4G network, it should be appreciated that the same concepts apply to 5G or other-G networks as well that include a reference signal similar to PDCCH.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method of providing dynamic Physical Downlink Control Channel (PDCCH) power allocation, comprising:
dividing a transmit power over all resource elements (REs) in a subframe at a first symbol time;
determining how many REs will be in use at a second symbol time;
determining how much additional power will be available at the second symbol time; and
dividing and allocating at least a portion of the determined additional power over REs assigned for PDCCH resources for use during the second symbol time.

2. The method of claim 1, further comprising performing the method at a scheduler in communication with an eNodeB.

3. The method of claim 1, further comprising performing the method at a network node performing media access control (MAC) scheduling.

4. The method of claim 1, wherein the first symbol time and the second symbol time are two transmission time intervals (TTIs) apart.

5. The method of claim 1, wherein the first symbol time and the second symbol time are at least two transmission time intervals (TTIs) apart.

6. The method of claim 1, further comprising performing the method in a multi-radio access technology (multi-RAT) telecommunications network.

7. The method of claim 1, further comprising evenly dividing a transmit power over all resource elements (REs) in a subframe at a first symbol time, and, evenly dividing and allocating the determined additional power over REs assigned for PDCCH resources for use during the second symbol time.

8. The method of claim 1, further comprising allocating a portion of the determined additional power to a cell specific reference signal.

9. The method of claim 1, further comprising selecting a lower aggregation level for an eNodeB signal.

10. The method of claim 1, further comprising determining the transmit power based on a power level available at an antenna of the eNodeB.

11. The method of claim 1, further comprising adding power based on a number of unused subcarriers at the first symbol time.
